(19) United States
(12) Patent Application Publication
(10) Pub. No.: US 2011/0142738 A1
(43) Pub. Date: Jun. 16, 2011

(54) METHOD FOR TREATING SPENT REGENERATION GAS

(75) Inventors: Keyur Y. Pandya, Elgin, IL (US); Ernest J. Boehm, JR., Hanover Park, IL (US); William J. Lechnick, Glen Ellyn, IL (US); Jessy E. Trucko, Lake Forest, IL (US); Douglas E. Kuper, Chicago, IL (US); Lamar A. Davis, West Dundee, IL (US); David L. Holbrook, Rapid City, SD (US); Luk G.J. Verhulst, Antwerp (BE); Jonathan A. Tertel, Mount Prospect, IL (US)

(73) Assignee: UOP LLC, Des Plaines, IL (US)

(21) Appl. No.: 12/958,699

(22) Filed: Dec. 2, 2010

Related U.S. Application Data
(60) Provisional application No. 61/287,190, filed on Dec. 16, 2009.

(51) Int. Cl. B01D 53/52

(52) U.S. Cl. 423/224

(57) ABSTRACT

The invention covers a method for treating spent regeneration gas from one or more molecular sieve treaters, first in an amine solvent unit and then in a caustic unit. The amine solvent unit removes hydrogen sulfide and carbonyl sulfide and the caustic unit removes mercaptans. Optionally, there are additional treatments before the treated gas has met specifications for burning as a fuel or used for other purposes.

### CROSS-REFERENCE TO RELATED APPLICATION

This application claims priority from Provisional Application No. 61/287,190 filed Dec. 16, 2009, the contents of which are hereby incorporated by reference.

### BACKGROUND OF THE INVENTION

This invention provides a method for treating spent regeneration gas. More particularly, this invention treats the spent regeneration gas from one or more molecular sieve beds in first an amine solvent unit and then in a caustic unit.

In the past, spent regeneration gas from molecular sieve treaters has typically been sent to fuel to be burned in the refinery or gas processing complex in which it was produced. Today, environmental restrictions on the emission of sulfur compounds, which are present at low levels in spent regeneration gas from molecular sieve beds, prevent this gas from being considered as fuel without removal of these sulfur compounds prior to burning. Removal of these sulfur compounds, which are comprised of H₂S, COS, and various mercaptan sulfur species, proves difficult using conventional gas treating methods. Amine systems cannot remove the mercaptan sulfur or the COS to the required levels. Mercaptan oxidation systems such as those sold by UOP LLC, Des Plaines, Ill., under the Merox trademark or other regenerated oxidative caustic mercaptans removal systems have problems with both the COS and H₂S, requiring the additional treating steps and excessive ongoing chemicals usage for treating. Physical solvent systems have been commercially proven at efficiently removing all of the various sulfur species to the required levels from the spent regeneration gas exiting from a gas phase molecular sieve unit. These gas phase systems typically have very small levels of C₂+ hydrocarbons involved in either the gas to be treated, the regeneration gas, or in the subsequent spent regeneration gas. When the spent regeneration gas is coming from a liquid phase treater, such as those used for treating propane and butane, the regeneration gas, which is typically methane, can contain upwards of 30 mol- % C₃ and C₄ hydrocarbons. These heavier hydrocarbons are co-absorbed in the absorption unit by the solvent such as in a Selexol unit sold by UOP LLC. The Selexol process uses a physical solvent made of a dimethyl ether of polyethylene glycol to remove hydrogen sulfide, carbon dioxide, and other sulfur impurities including mercaptans and carbonyl sulfides. Approximately 60% of the C₃ and 80% of the C₄ can be co-absorbed in the absorption unit and subsequently end up in the acid gas stream routed from the regenerator to the sulfur recovery unit. This amount of hydrocarbon is devastating to the operation of a Claus sulfur recover unit, which is the predominant method for sulfur recovery in the industry. This limitation of hydrocarbon in the sulfur recovery unit severely limits the effectiveness of a physical solvent system, such as Selexol, in this application. Molecular sieve regeneration is a cyclical process which has variation in the concentration of hydrocarbon and sulfur contaminates in the feed to downstream units. This increases the size of circulation rates of solvent to handle peak sulfur contaminant levels. As well because of the cyclical nature of regeneration cycles there are changes in the from the molecular sieve treaters. Designs of such amine units, Selexol units and mercaptan oxidation units need to have means of dampening the feed rate variation in order to maintain a consistent operation to maintain the desired treated gas sulfur specification.

This invention removes all the sulfur contaminants using two gas processing technologies. This invention first removes H₂S and COS in Amine system that is capable of removal of H₂S and CO₂ down to a low level as well as removing a large fraction of the COS in the feed gas to the amine unit (e.g. UOP's Amine Guard FS). Treated gas from Amine systems is then reacted in caustic treating unit (e.g. UOP's Merox™ Systems) to remove the mercaptans using caustic solution. Caustic treating unit may require a caustic prewash to remove the minimal amount of CO₂ and H₂S in the Merox™ feed gas. Also a COS solvent wash may be required to remove the COS that is not captured in the Amine unit that enters as the caustic treating unit as feed. This invention is unique in that it has not been considered as a method for treating spent regeneration gas from molecular sieve treaters because 1) the spent regeneration gas has typically been sent to fuel and 2) liquid phase treaters are typically found in LNG or LPG complexes where the spent regeneration gas from the C₃ and C₄ treaters can be recycled back to the front end of the unit to be amine treated and then treated in a gas phase molecular sieve treater. Regeneration gas can also be bypassed around the molecular sieve units to maintain feed rates.

The current invention first removes H₂S and COS species from one or more molecular sieve treaters using an amine system (e.g. Amine Guard FS as marketed by UOP LLC, Des Plaines, Ill.). An amine solvent does not have high affinity towards the hydrocarbon species minimizing a high hydrocarbon pick-up in acid gas. The acid gas from amine system contains less than 5 mol- % of the hydrocarbon present in spent regeneration gas. The treated gas is then sent to caustic treating unit for removing mercaptans followed by polishing for COS using amine or caustic solution, thus achieving sulfur spec to burn it as a fuel.

The spent regeneration gas from one or more molecular sieve treaters is mixed, and then passed through a Amine unit where the it is reacted with Amine solvent to removal H₂S and COS to very low level without co-absorbing significant amounts of hydrocarbon. This will also reduce the CO₂ in treated gas as it will absorb in amine solvent. Amine solvent is regenerated in amine regenerator. The amine scrubbing unit can produce a treated gas stream containing as little H₂S as possible and an acid gas stream with very little hydrocarbon content, certainly suitable for a Claus type sulfur recovery unit.

The treated gas is then sent to the caustic treating unit. The amine-treated gas is treated with caustic to absorb the mercaptans which are then oxidized to disulfides so that they can be separated as a waste stream from the caustic. The treated gas exiting the caustic unit is washed to remove traces of COS as needed to meet the sulfur specs so that it can be burned as a fuel in refinery. A caustic prewash up stream of the caustic treating unit may be required if CO₂ and H₂S levels are too high for operation of a caustic treating unit.

Because of the cyclic nature of this system, which results from the non-steady-state operation of the molecular sieve units, the overall gas flow through the system is not constant. To minimize the negative effect of this variation in flow on the processing units in the system, one of the two flow scheme presented (with dotted lines) can be used. Under option 1, the system can be equipped with a recycle gas compressor on the treated gas. This compressor and a flow controller work to provide a constant flow of gas into the amine scrubbing unit and the caustic treating unit. Under a second option, the fresh regeneration gas can be by-passed around the molecular sieve beds to give constant flow to the amine and mercaptans oxidation units. For the later option, molecular sieve units have to be modified to add the bypass-line so that near constant feed rate can be maintained.

Since low molecular weight mercaptans are soluble in caustic soda (NaOH), when treating feedstocks such as natural gases and refinery gases, it is feasible to remove these mercaptans by NaOH extraction. The extraction reaction is shown by the following equation:

RSH+NaOH→NaSR+H₂O

Extraction equilibrium is favored by lower molecular weight mercaptans and lower temperatures. The rich caustic containing the extracted mercaptans in the form of sodium mercaptides, is regenerated as shown in the equation given below:

4 NaSR+O₂+2 H₂O→2 RSSR+4 NaOH.

The reaction is accelerated to an economically acceptable rate at mild conditions by a catalyst which is dispersed in the aqueous caustic solution. A gas extraction caustic unit will normally consist of a combination column that includes prewash, extraction, and water wash sections. A caustic regeneration system will convert the extracted mercaptans to disulfide oil that is separated and removed, while the regenerated caustic is returned to the extraction section. Feedstock enters the bottom of the combination column into the prewash section. The gas passes upward through the trays of the prewash section where it is contacted with circulating caustic solution for removal of H₂S and CO₂. The gas leaving the prewash section flows upward through the trayed extraction section where it is contacted with regenerated caustic that enters at the top of the extraction section. Mercaptans are absorbed into the caustic solution through intimate counter-current contact between caustic and feed. The water wash section is located above the extraction section. The gas from the extraction section passes upward through the trays of the water wash where water is counter-currently circulated to remove traces of entrained caustic from the treated gas. The rich caustic containing the extracted mercaptans flows from the bottom of the extraction section to the caustic regeneration section. In the caustic regeneration section, the mercaptan rich caustic solution, containing the catalyst, is injected with air and the mixture flows into the oxidizer.

1. A process for removing sulfur contaminants from a hydrocarbon gas stream, said process comprising first sending said gas stream to an amine solvent system to remove hydrogen sulfide and COS from said gas stream and then sending said gas stream to a caustic treating unit to remove mercaptans from said gas stream.

2. The process of claim 1 wherein said hydrocarbon gas stream comprises methane.

3. The process of claim 2 wherein said hydrocarbon gas stream further comprises C₂+ hydrocarbons.

4. The process of claim 1 wherein said gas stream is a regenerative gas stream wherein at least part of said regenerative gas stream has passed through an adsorbent bed.

5. The process of claim 1 wherein after said gas stream passes through the caustic treating unit, said gas stream is again treated in an amine solvent system or a caustic treating unit to provide further removal of hydrogen sulfide and COS in said amine solvent system or further removal of mercaptans.

6. The process of claim 1 wherein after said gas stream has passed through said caustic treating unit said gas stream is burned as fuel.

7. The process of claim 1 wherein after said gas stream has passed through said caustic treating unit said gas stream is used as a regeneration gas for an adsorbent bed.

8. The process of claim 1 wherein said process removes at least 80% of said sulfur contaminants from said hydrocarbon gas stream.

9. The process of claim 1 wherein said process removes at least 90% of said sulfur contaminants from said hydrocarbon gas stream.

10. The process of claim 1 wherein said process removes at least 95% of said sulfur contaminants from said hydrocarbon gas stream.

11. The process of claim 1 wherein said gas stream comprises a steady flow of gas.

12. The process of claim 11 wherein at least a portion of said gas stream is sent directly to said amine solvent bed without first passing through an adsorbent bed as a regeneration gas stream.
